(19) United States
(12) Patent Application Publication
(10) Pub. No.: US 2003/0105668 A1
(43) Pub. Date: Jun. 5, 2003

(54) Goods information collecting system and method

(75) Inventors: Satoko Segawa, Kawasaki (JP); Akihiko Obata, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/084,358

(22) Filed: Feb. 28, 2002

(30) Foreign Application Priority Data
Nov. 30, 2001 (JP) 2001-367214

(51) Int. Cl. G06F 17/60

(52) U.S. Cl. 705/14; 705/26

(57) ABSTRACT

A goods information collecting system for collecting information on goods on a network gives a contribution right to a user, records and manages an article when the user contributes the article, associates the article with information on goods, generates a link to the information on goods, displays the article, records and manages an operation history of other users with respect to the displayed article, calculates an influence degree showing the degree to which the contributed contents have an effect on the goods selection of other users, and generates a point given to the user contributing the article, based on the calculated influence degree.

### BACKGROUND OF THE INVENTION

1. Field of the Invention

The present invention relates to a goods information collecting system and method, in which a user contributes an article on goods provided on the network with respect to information thereon, an influence degree that is an index indicating how the contents of the article have an effect on the determination of another user for selecting and purchasing the goods is obtained, and based on the obtained influence degree, a point to be an incentive for providing information is given to the user who has contributed to the sales of the goods.

2. Description of the Related Art

Due to the rapid widespread use of the network environment, it is relatively becoming easy to collect information useful for users to purchase goods, such as opinions and feedback on the goods, from general consumers. Typical methods include: using an electronic bulletin board on which a user can freely write opinions, feedback, etc. on particular goods; measuring how many recommenders exist regarding particular goods; providing, for example, a recommendation button for the respective goods, and determining if the goods can be recommended based on the number of times or probability at which a recommendation button has been pressed by users; and the like.

The summarization of opinions, feedback, evaluation points of goods, and the like collected by the above-mentioned methods are made public to general consumers (third party) on the network. The general consumers refer to these pieces of information, thereby selecting goods more efficiently and purchasing them.

In order to implement the above-mentioned methods on the network, it is important to collect a large amount of information on goods exactly. As a method for inviting purchasers to provide evaluations, opinions, and the like, the function of providing a contributor with a point such as a discount in accordance with the number of contributions is added, whereby an incentive is given to general consumers with respect to a contribution act. As the incentive for contribution becomes higher, it becomes easier to ensure the amount of information to be provided.

However, according to the above-mentioned conventional incentive providing method, the degree of an incentive is determined based on the number of contributions, the amount of contributions, etc. Therefore, a user can obtain an unfair incentive by intentionally writing a number of simple opinions. More specifically, in the case of point providing service, the same user writes simple feedback such as “good” or “bad” a number of times, whereby a number of points are given to the user.

Regarding the same user, the following methods and the like are considered: the number of contributions with respect to the same goods is limited to once; and the contents of contributions are periodically monitored, whereby a user having an intention of obtaining an unfair incentive is specified to be excluded.

However, according to the former method, there is a possibility that effective information cannot be collected. According to the latter method, it is difficult to specify a user having an intention of obtaining an unfair incentive, and the range to be monitored is limited physically and in terms of time. Therefore, the user cannot be excluded completely. The other conceivable methods cannot solve the problems.

### SUMMARY OF THE INVENTION

Therefore, with the foregoing in mind, it is an object of the present invention to provide a goods information collecting system and method for providing an incentive in accordance with the degree to which information obtained by contribution has an effect on other users.

In order to achieve the above-mentioned object, the goods information collecting system of the present invention for collecting information on goods on a network, includes: an article contributing part for receiving contribution of an article on the goods; an article recording and managing part for recording and managing the contributed article; an article•goods linking part for associating the article with information on goods, and generating a link to the information on goods; an article display part for displaying the article; a log recording and managing part for recording and managing an operation history of users other than a contributor with respect to the displayed article; an influence degree calculating part for calculating an influence degree of the article on sales of the goods based on the operation history; and a point generating and managing part for generating and managing a point to be an incentive for purchasing goods for each contributor, based on the influence degree, wherein the point is generated based on the operation history of other users with respect to the contributed article.

Because of the above-mentioned configuration, an incentive for contribution of an article can be given based on the influence degree of the contents of a contributed article on the goods selection of other users. Therefore, unfair contribution of an article can be excluded, and it can be expected that only the effective information is provided in a large number.

Furthermore, in order to achieve the above-mentioned object, the goods information collecting system of the present invention for collecting information on goods on a network in an EC (Electric-Commerce) site, includes: an article contributing part for receiving contribution of an article on the goods; an article recording and managing part for recording and managing the contributed article; an article•goods linking part for associating the article with information on goods, and generating a link to the information on goods; an article display part for displaying the article; a log recording and managing part for recording and managing an operation history of other users with respect to the displayed article; an influence degree calculating part for calculating an influence degree of the article on sales of the goods based on the operation history; and a point generating and managing part for generating and managing a point to be an incentive for purchasing goods for each contributor, based on the influence degree, wherein the point is generated based on the operation history of other users with respect to the contributed article.

Because of the above-mentioned configuration, even in an EC site realizing electronic transactions, an incentive for contribution of an article can be given based on the influence degree of the contents of a contributed article on the goods selection of other users that are general consumers. Therefore, unfair contribution of an article can be excluded, and it can be expected that only the effective information is provided in a large number.

Furthermore, it is preferable that the goods information collecting system of the present invention further includes a contribution right providing part for providing a user with a contribution right, wherein the article contributing part receives contribution of an article only from the user provided with the contribution right.

Furthermore, in the goods information collecting system of the present invention, it is preferable that the contribution right providing part further includes a user information managing part for storing a purchase record of the user, and the contribution right is given only to the user who has a purchase record of goods targeted for contribution. Because of this configuration, only the contribution of an article on goods actually purchased can be collected, so that ineffective contribution of an article for the purpose of gaining points can be prevented in advance.

Furthermore, in the goods information collecting system of the present invention, it is preferable that the influence degree is calculated based on a purchase number or a purchase amount obtained when users other than a contributor of an article on particular goods access information on the particular goods based on the article and purchase the particular goods.

Furthermore, in the goods information collecting system of the present invention, it is preferable that the influence degree is calculated as a ratio of a purchase number or a purchase amount obtained when users other than a contributor of an article on particular goods access information on the particular goods based on the article and purchase the particular goods, with respect to a sold number or a sold amount of the particular goods in a predetermined period. This is because a higher incentive can be given to a user who has contributed an article contributing to the actual increase in a sold number or sold amount.

Furthermore, in the goods information collecting system of the present invention, it is preferable that the point generating and managing part increases/decreases the point in inverse proportion to a ratio of the number of accesses to information on the goods prior to contribution of an article on the goods, with respect to the desired number of accesses to the goods. This is because, in the case where chances of purchasing goods increase due to a contributed article, a higher incentive can be given to a user who has contributed the article.

Furthermore, the present invention is directed to the method for collecting information on goods on a network: receiving contribution of an article on the goods; recording and managing the contributed article; associating the article with information on goods, and generating a link to the information on goods; displaying the article; recording and managing an operation history of other users with respect to the displayed article; calculating an influence degree of the article on sales of the goods based on the operation history; and generating and managing a point to be an incentive for purchasing goods for each contributor, based on the influence degree, wherein the point is generated based on the operation history of other users with respect to the contributed article, and to a computer-readable recording medium storing a program for implementing the above-mentioned method.

These and other advantages of the present invention will become apparent to those skilled in the art upon reading and understanding the following detailed description with reference to the accompanying figures.

### BRIEF DESCRIPTION OF THE DRAWINGS

FIG. 1 shows a configuration of a goods information collecting system of an embodiment according to the present invention.

FIG. 2 shows a configuration of a contribution right providing part in the goods information collecting system of the embodiment according to the present invention.

FIG. 3 illustrates an example of an input screen of the contribution right providing part in the goods information collecting system of the embodiment according to the present invention.

FIG. 4 illustrates an example of a data configuration of a user information database in the goods information collecting system of the embodiment according to the present invention.

FIG. 5 illustrate an input screen of an article contributing part in the goods information collecting system of the embodiment according to the present invention.

FIG. 6 illustrates an example of a data configuration of an article management database in the goods information collecting system of the embodiment according to the present invention.

FIG. 7 illustrates HTML (Hypertext Markup Language) text showing the contents of an article in the goods information collecting system of the embodiment according to the present invention.

FIG. 8 shows a configuration of an article•goods linking part in the goods information collecting system of the embodiment according to the present invention.

FIGS. 9A and 9B illustrate an example of a link in the goods information collecting system of the embodiment according to the present invention.

FIG. 10 illustrates an example of display contents in an article display part in the goods information collecting system of the embodiment according to the present invention.

FIG. 11 illustrates an example of a data configuration of a log recording database in the goods information collecting system of the embodiment according to the present invention.

FIG. 12 shows a processing flow in the goods information collecting system of the embodiment according to the present invention.

FIG. 13 illustrates a computer environment.

### DESCRIPTION OF THE PREFERRED EMBODIMENTS

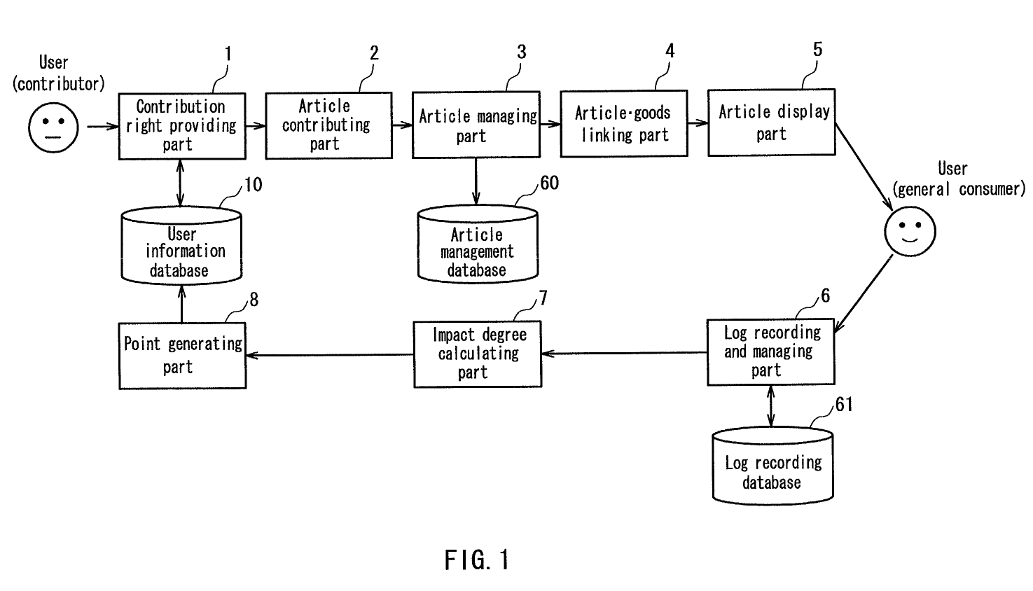

Hereinafter, a goods information collecting system of an embodiment according to the present invention will be described with reference to the drawings. In the embodiment, as a typical example, a system will be described, in which an article can be contributed with respect to information on displayed goods in an electronic commerce (EC) site capable of conducting electronic transactions in the Internet environment. FIG. 1 shows a configuration of the goods information collecting system of the embodiment according to the present invention.

In FIG. 1, reference numeral 1 denotes a contribution right providing part for determining whether a user who desires to contribute an article has predetermined conditions for providing information on goods, and issuing a contribution right to the user only in the case where the user has the conditions.

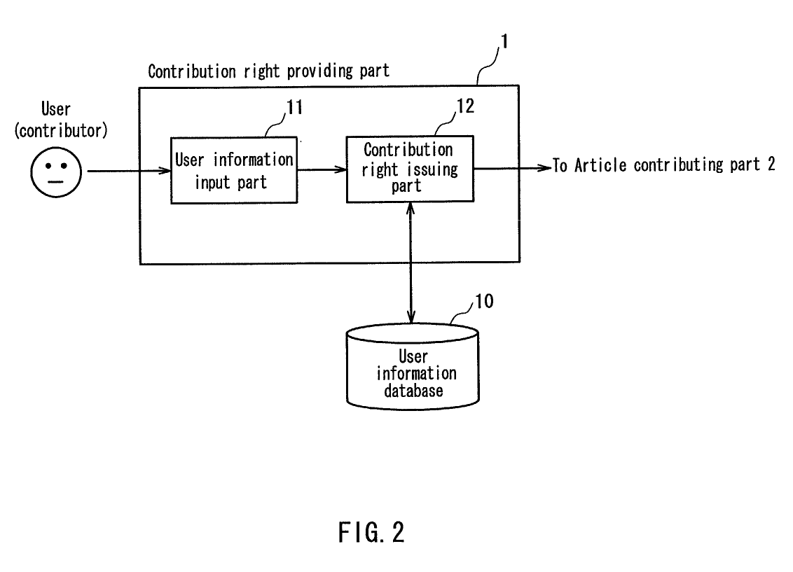

As shown in FIG. 2, the contribution right providing part 1 is composed at least of a user information input part 11 and a contribution right issuing part 12.

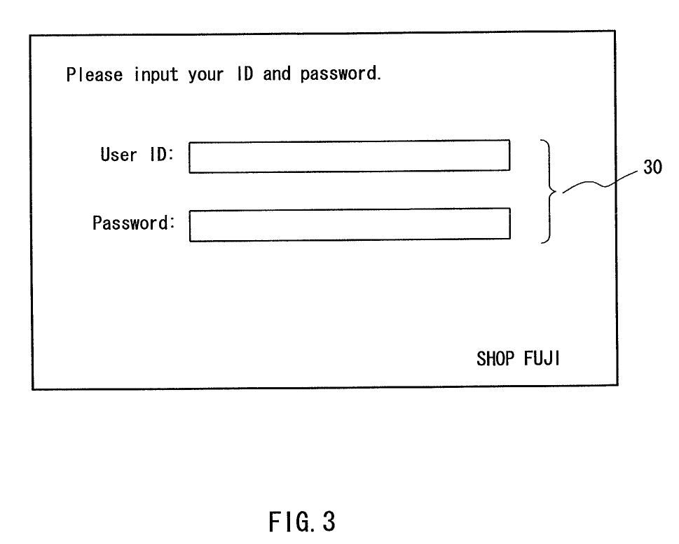

In order to specify a user, a user inputs information (a user ID, a password, etc.) for identifying an individual in the user information input part 11. As an example of an actual input screen, an initial display screen of a web in a predetermined EC site has an input region 30 for inputting a user ID and a password as shown in FIG. 3.

Then, the contribution right issuing part 12 confirms whether the user has been registered in a user information database 10 by referring thereto, using the input information (a user ID, a password, etc.) for identifying an individual as key information. Only in the case where the user has been registered in the user information database 10, the contribution right issuing part 12 issues a contribution right, and displays a web display screen containing a contribution form to the user.

As conditions for providing a contribution right, there is no particular limit to the above-mentioned method, and any method enabling an individual to be identified may be used. For example, a confirming method using a voiceprint by voice input, or a confirming method using pattern recognition based on a fingerprint and a face picture may be used.

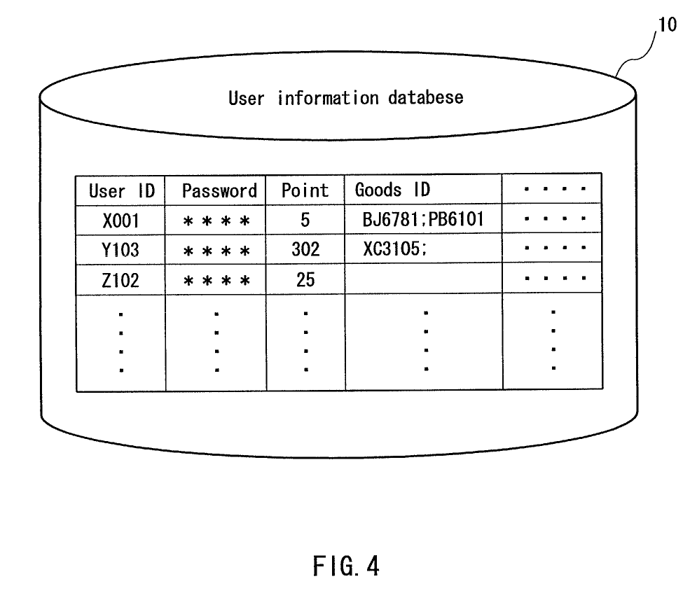

The user information database 10 stores the information for identifying a customer. FIG. 4 shows an example of a data configuration of the user information database 10. In FIG. 4, points for point service obtained by users, goods IDs indicating the goods purchased in the past, as well as user IDs and passwords are managed. The data configuration of the user information database 10 is not particularly limited to that shown in FIG. 4.

As an example of a method for limiting users who will be given a contribution right, it is also conceivable that only the users who have purchased the goods will be given a contribution right. By limiting users to those who have actually purchased goods, only specific and useful information can be collected. According to such a method, a contribution right can be confirmed at a time of contribution of an article.

In this case, as shown in FIG. 4, goods IDs indicating goods purchased by the respective users in the past are stored in the user information database 10, whereby the right of contributing an article is issued only regarding the goods purchased by the users in the past.

Furthermore, in a contribution screen in the article contributing part 2, a page regarding goods is displayed in the EC site, and the goods are displayed by user's click on the goods using a mouse or the like.

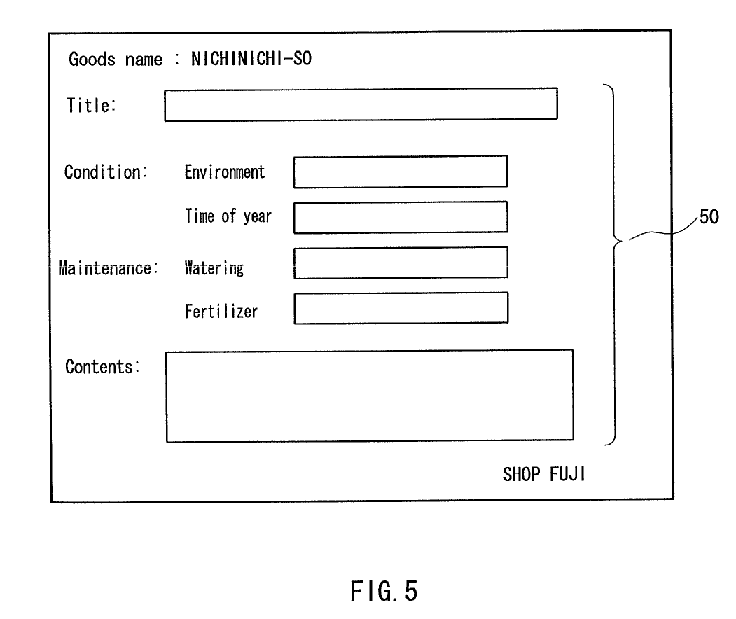

Reference numeral 2 denotes an article contributing part for a user to input an article on goods and transmit it by displaying the input screen as shown in FIG. 5 on a web screen. In an example of the web screen display shown in FIG. 5, an input region 50 is provided for each item, regarding the contents to be contributed by a user with respect to goods “Madagascar periwinkle”.

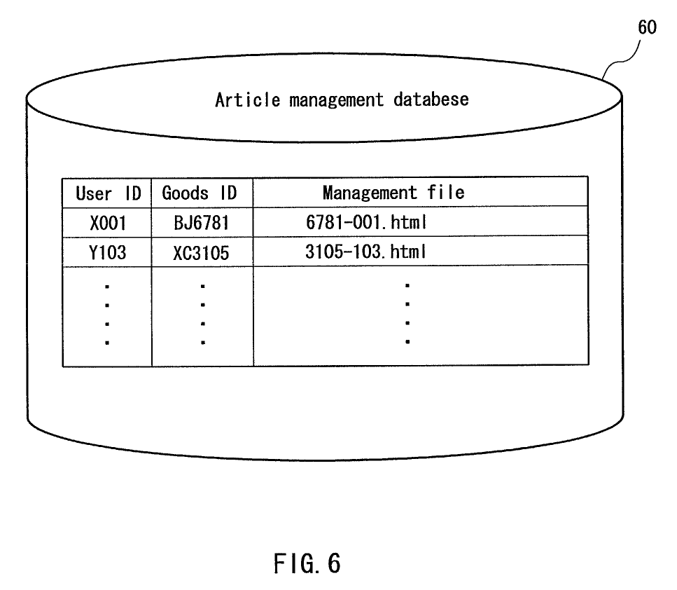

The contents contributed in the article contributing part 2 are stored and managed in an article management database 60 by an article managing part 3. FIG. 6 shows an example of a data configuration of the article management database 60. In FIG. 6, the name of an HTML file in which the contents of an article are to be displayed is stored for each goods ID, whereby the contents of an article can be stored in such a manner that they can be easily confirmed on the web.

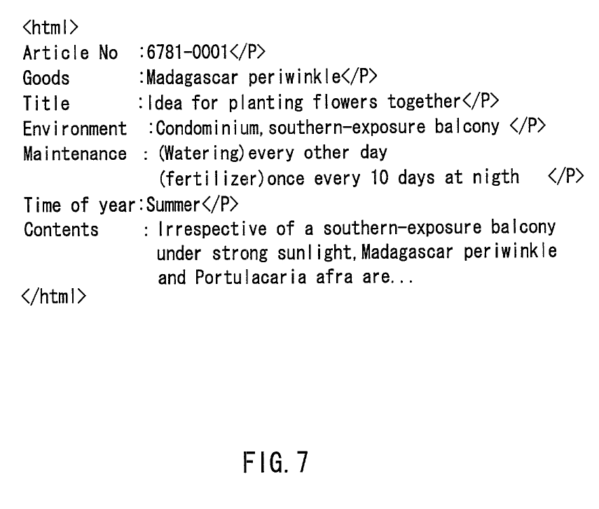

For example, the contents of a contributed article on a goods ID “BJ6781” purchased by a user ID “X001” are stored in a file “6781-001.html” as shown in FIG. 6, and the contents of the file are stored, for example, as HTML text as shown in FIG. 7.

Reference numeral 4 denotes an article•goods linking part for associating goods related information (page regarding goods) with a contributed article managed by the article managing part 3. Each article may be associated with each goods related information or a plurality of pieces of goods related information. By providing an electronic bulletin board or the like regarding goods in the EC site, association may also be conducted.

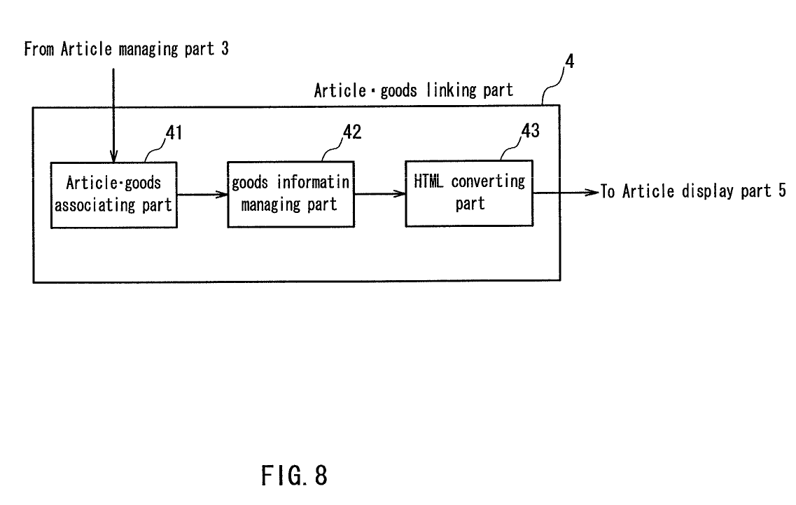

As shown in FIG. 8, the article•goods linking part 4 includes at least an article•goods associating part 41 for associating goods with text data described in the item “contents” in an article to be contributed by a user, a goods information managing part 42 for managing the association between the respective goods and the information on the goods, and an HTML converting part 43 for converting contributed text data into HTML text and linking HTML text to the information on the goods.

The article•goods associating part 41 specifies goods targeted for contribution of an article by a user. Various methods are conceivable for a user to specify goods. Examples of the methods include: previously selecting goods targets for contribution of an article by a user; specifying goods by reading a bar code of goods; selecting a bulletin board prepared for the respective goods and writing an article thereon; and the like.

When goods targeted for contribution of an article are specified, the goods information managing part 42 extracts a file name and a URL name storing information on the corresponding goods. The HTML converting part 43 generates HTML text linked to the file name and the URL name storing the information on the goods.

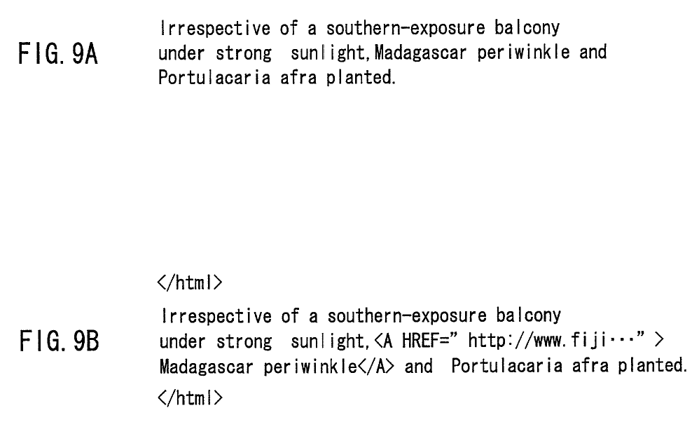

For example, contributed text data as shown in FIG. 9A is converted into HTML text by adding “<html>” and “</html>” before and after the text data as shown in FIG. 9B, and “Madagascar periwinkle” specified as a goods name is replaced by “<A HREF=HYPERLINK “http://www.fuji.••/A.html $1=0234-1” http://www.fuji.••/A.html$1=0234-1> Madagascar periwinkle </A>”, whereby a link to “HYPERLINK “http://www.fuji.••A.html” http://www.fuji.••/A.html” is generated.

Herein, “$1=0234-1” represents a link number. A link destination clicked on by a user can be identified using this link number as an argument. In other words, if the link number is recorded, it becomes possible to trace a history through which the user has accessed goods information.

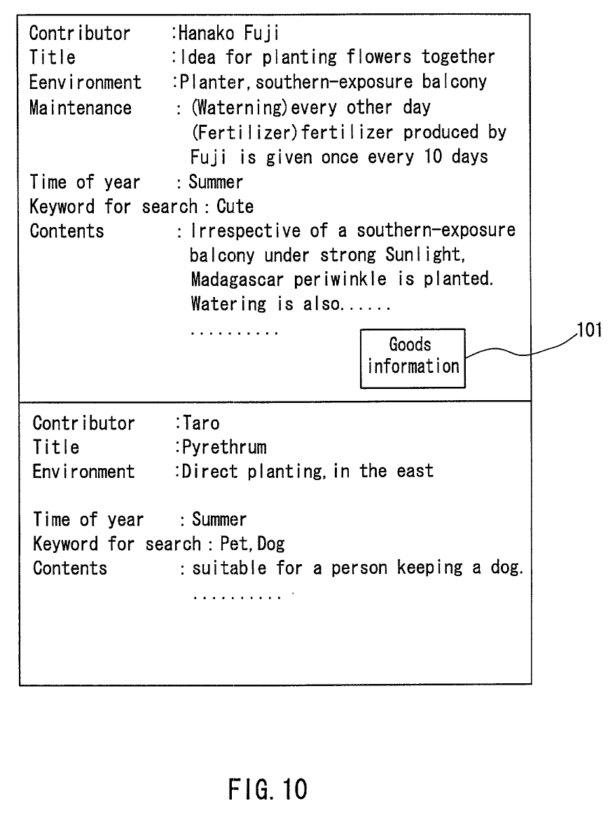

Reference numeral 5 denotes an article display part for displaying the contents contributed by utilizing an electronic bulletin board or the like on a web or the like. For example, FIG. 10 shows an example of an article display using an electronic bulletin board. As shown in this figure, contents are displayed in the order of contributions, and an information obtaining button 101 is provided, which is capable of displaying information on linked goods by clicking when a user desires to obtain information on goods.

Reference numeral 6 denotes a log recording and managing part for recording and managing, in a log recording database 61, what kind of screen operations are conducted by other users (general consumers) after they have seen a displayed contributed article.

It is assumed that other users who are general consumers are also those who are registered in the user information database 10. Therefore, in the case where a user who has not been registered in the user information database 10 desires to access information on goods based on a contributed article, the information on goods are displayed to the user after the registration in the user information database 10 is completed.

More specifically, a link number is recorded in the log recording database 61 at a time of clicking so as to determine which link has been clicked on by other users who are general consumers after seeing contributed contents displayed on a web screen in the article display part 5. In an example shown in FIG. 9B, a link number “0234-1” is recorded in the log recording database 61.

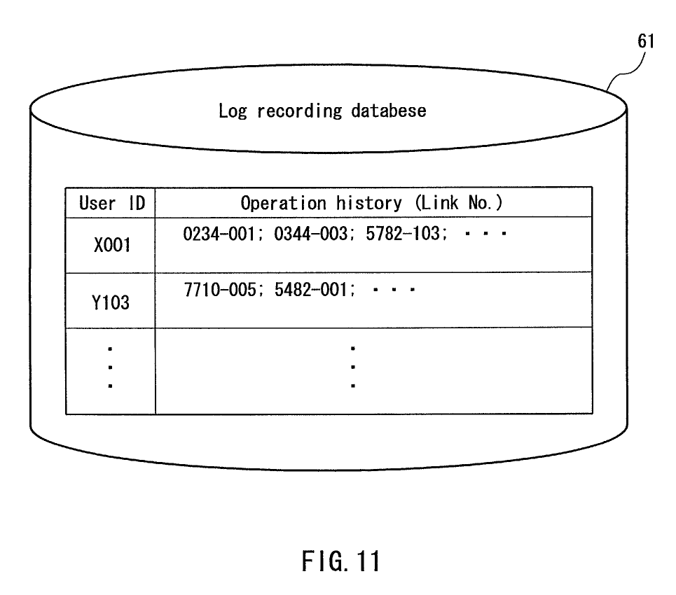

FIG. 11 shows an example of a data configuration of the log recording database. As shown in FIG. 11, tracking of link numbers clicked on is recorded for each user ID. Because of this, it is easily determined which goods users are interested in.

Reference numeral 7 denotes an influence degree calculating part for calculating the degree to which the contents of a contributed article has an effect on the goods selection of other users who are general consumers. That is, the influence degree calculating part 7 calculates an index indicating the degree to which a contributed article contributes to the sales of goods related to the article as an influence degree of the contributed article.

More specifically, the influence degree calculating part 7 determines, as an influence degree, that other users have accessed the contributed article and the access has led to the purchase of goods corresponding to the contributed article.

The following calculation methods are considered. First, there is a method in which an influence degree is calculated based on how many and how much the goods in the EC site have been purchased on the basis of a contributed article.

According to the above method, it is possible to directly evaluate the degree to which the contributed article contributes to the sold number or sold amount. Therefore, in the case where a user contributes an article that has contributed to the sold number or sold amount, the user can expected to obtain a larger incentive.

There is also a method for calculating, as an influence degree, a percentage using the total sold number or total sold amount regarding the goods in the EC site as a denominator, and the sold number or sold amount obtained when users access information on goods contained in a contributed article based thereon and purchase them as a numerator. In this case, a point to be given is obtained by multiplying a predetermined point per 1% by a percentage.

Because of this, in the case where a user contributes an article with respect to goods whose sold number or sold amount is low at a time of contribution, it can be determined that the effect of promoting the sales of the goods is higher. Therefore, a larger incentive can be expected when contributing an article with respect to unpopular goods, rather than contributing an article with respect to popular goods whose sold number or sold amount is already high. Thus, the effect of sales promotion of unpopular goods can be expected.

It is preferable to accumulate the sold number or sold amount in a predetermined period (e.g., one month, three months, a half year, or the like). This is because average tracking can be grasped. It may also be possible that an influence degree is calculated every time other users purchase goods contained in the contributed article based on information on the goods without providing a predetermined period (in the case where a predetermined period is zero).

The following is also considered: prior to contribution of an article, in the case where the number of accesses to information on goods contained in the article is smaller than that desired by the party providing the goods, when the number of accesses exceed the desired one due to the contribution of an article, a higher point is given.

That is, as an article is contributed with respect to goods whose popularity is lower, a higher point will be given with respect to the effect thereof.

More specifically, the influence degree is varied in inverse proportion to a percentage using the desired access number as a denominator and the number of accesses to information on goods contained in the article prior to the contribution of an article as a numerator. Herein, a varied ratio of an influence degree is obtained instead of an influence degree itself. The varied influence degree can be obtained by multiplying an influence degree (that has already been obtained) by the percentage.

Because of the above, in the case where an article is contributed with respect to goods with less popularity, and the number of accesses to information on the goods is increased, provision of a higher incentive can be expected. Therefore, it is possible to allow users to have a predetermined motivation for contribution of an article with respect to goods with less popularity.

Reference numeral 8 denotes a point generating part for generating a point used for discount service or the like provided for giving an incentive for contribution of an article based on a calculated influence degree and giving the point to a user who has contributed the article.

The point and influence degree may be values that linearly correspond to each other. Alternatively, it may be possible to use a method for generating a point in a step form, which gives a predetermined point in a predetermined range of an influence degree. Furthermore, the generated point is given by updating the contents of the user information database 10. The obtained point can be used for receiving discount service or the like when a user purchases goods or service in the EC site.

As described above, in the present embodiment, an incentive for contribution of an article can be given based on the influence degree of the contents of a contributed article on the goods selection of other users that are general consumers. Therefore, unfair contribution of an article can be excluded, and only effective information can be provided.

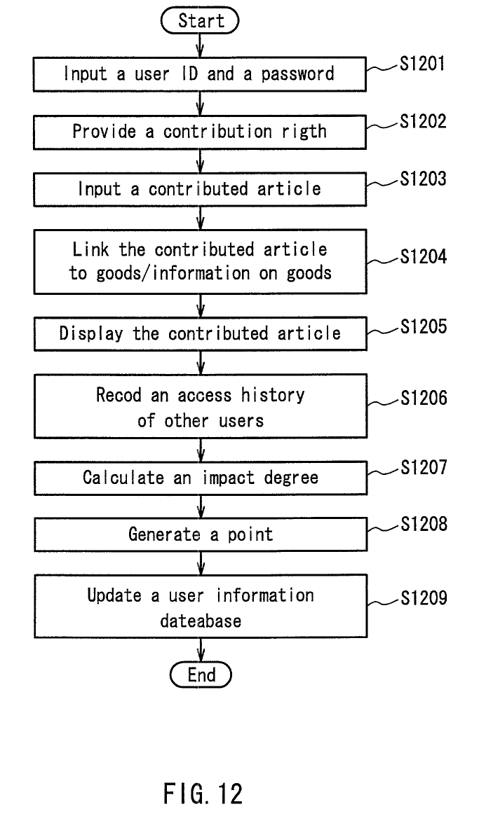

Next, a processing flow of a program for realizing the goods information collecting system of the embodiment according to the present invention will be described. FIG. 12 shows a flow chart illustrating processing of a program for realizing the goods information collecting system of the embodiment according to the present invention.

In FIG. 12, a user having an intention of contributing an article inputs a user ID and a password (Operation 1201), and is provided with a contribution right with respect to am article under predetermined conditions (Operation 1202). Input of an article contributed by a user provided with the contribution right is accepted (Operation 1203).

Next, a link between the contributed article, and goods and information on the goods related to the contributed article is generated (Operation 1204), and the contributed article is displayed with link information (Operation 1206).

When the third party browses through the article, an access history such as an operation history with respect to the link information is recorded (Operation 1206), and an influence degree of the contributed article is calculated based on the access history (Operation 1207).

A point to be an incentive for contribution of an article is generated based on the calculated influence degree (Operation 1208), and a point is given to a user that is a contributor by updating a user information database (Operation 1209).

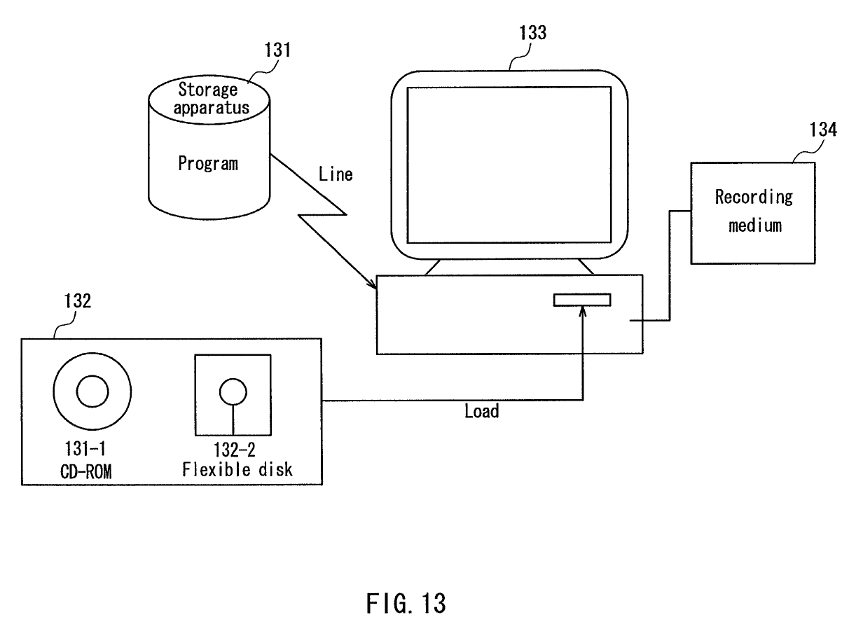

The program for realizing the goods information collecting system of the embodiment according to the present invention may be recorded not only onto a portable recording medium 132 such as a CD-ROM 132-1 and a flexible disk 132-2, but also onto another storage apparatus 131 provided at the end of a communication line and a recording medium 134 such as a hard disk and a RAM of a computer 133, as shown in FIG. 13. In execution, the program is loaded, and executed on a main memory.

The user information database or the like generated by the goods information collecting system of the embodiment according to the present invention may also be recorded not only onto a portable recording medium 132 such as a CD-ROM 132-1 and a flexible disk 132-2, but also onto another storage apparatus 131 provided at the end of a communication line and a recording medium 134 such as a hard disk and a RAM of a computer 133, as shown in FIG. 13. For example, the user information database is read by the computer 133 when the goods information collecting system of the present invention is used.

In the embodiment, as a typical example, a system using an EC site capable of conducting electronic transactions in the Internet environment has been exemplified. However, the present invention is not limited thereto. Other embodiments such as an electronic transaction environment of a membership system using an electronic bulletin board may be used.

In the case of a word-of-mouth site utilizing an electronic bulletin board regarding goods, which does not use an EC site, a user can receive service such as a discount of a purchase price based on points at a time of purchase of goods/service at an ordinary shop related to the word-of-mouth site by presenting a membership No. of the word-of-mouth site, instead of using the points obtained in the EC site.

As described above, in the goods information collecting system of the present invention, an incentive for contribution of an article can be given based on the influence degree of the contents of a contributed article on the goods selection of other users that are general consumers. Therefore, unfair contribution of an article can be excluded, and it can be expected that only the information useful and effective for sales promotion of goods is provided.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A goods information collecting system for collecting information on goods on a network, comprising:
an article contributing part for receiving contribution of an article on the goods;
an article recording and managing part for recording and managing the contributed article;
an article•goods linking part for associating the article with information on goods, and generating a link to the information on goods;
an article display part for displaying the article;
a log recording and managing part for recording and managing an operation history of users other than a contributor with respect to the displayed article;
an influence degree calculating part for calculating an influence degree of the article on sales of the goods based on the operation history; and
a point generating and managing part for generating and managing a point to be an incentive for purchasing goods for each contributor, based on the influence degree,
wherein the point is generated based on the operation history of other users with respect to the contributed article.

2. A goods information collecting system for collecting information on goods on a network in an EC (Electric-Commerce) site, comprising:
an article contributing part for receiving contribution of an article on the goods;
an article recording and managing part for recording and managing the contributed article;
an article•goods linking part for associating the article with information on goods, and generating a link to the information on goods;
an article display part for displaying the article;
a log recording and managing part for recording and managing an operation history of other users with respect to the displayed article;
an influence degree calculating part for calculating an influence degree of the article on sales of the goods based on the operation history; and
a point generating and managing part for generating and managing a point to be an incentive for purchasing goods for each contributor, based on the influence degree,
wherein the point is generated based on the operation history of other users with respect to the contributed article.

3. A goods information collecting system according to claim 1, further comprising a contribution right providing part for providing a user with a contribution right, wherein the article contributing part receives contribution of an article only from the user provided with the contribution right.

4. A goods information collecting system according to claim 2, further comprising a contribution right providing part for providing a user with a contribution right, wherein the article contributing part receives contribution of an article only from the user provided with the contribution right.

5. A goods information collecting system according to claim 3, wherein the contribution right providing part further comprises a user information managing part for storing a purchase record of the user, and the contribution right is given only to the user who has a purchase record of goods targeted for contribution.

6. A goods information collecting system according to claim 4, wherein the contribution right providing part further comprises a user information managing part for storing a purchase record of the user, and the contribution right is given only to the user who has a purchase record of goods targeted for contribution.

7. A goods information collecting system according to claim 1, wherein the influence degree is calculated based on a purchase number or a purchase amount obtained when users other than a contributor of an article on particular goods access information on the particular goods based on the article and purchase the particular goods.

8. A goods information collecting system according to claim 2, wherein the influence degree is calculated based on a purchase number or a purchase amount obtained when users other than a contributor of an article on particular goods access information on the particular goods based on the article and purchase the particular goods.

9. A goods information collecting system according to claim 3, wherein the influence degree is calculated based on a purchase number or a purchase amount obtained when users other than a contributor of an article on particular goods access information on the particular goods based on the article and purchase the particular goods.

10. A goods information collecting system according to claim 5, wherein the influence degree is calculated based on a purchase number or a purchase amount obtained when users other than a contributor of an article on particular goods access information on the particular goods based on the article and purchase the particular goods.

11. A goods information collecting system according to claim 6, wherein the influence degree is calculated based on a purchase number or a purchase amount obtained when users other than a contributor of an article on particular goods access information on the particular goods based on the article and purchase the particular goods.

12. A goods information collecting system according to claim 1, wherein the influence degree is calculated as a ratio of a purchase number or a purchase amount obtained when users other than a contributor of an article on particular goods access information on the particular goods based on the article and purchase the particular goods, with respect to a sold number or a sold amount of the particular goods in a predetermined period.

13. A goods information collecting system according to claim 2, wherein the influence degree is calculated as a ratio of a purchase number or a purchase amount obtained when users other than a contributor of an article on particular goods access information on the particular goods based on the article and purchase the particular goods, with respect to a sold number or a sold amount of the particular goods in a predetermined period.

14. A goods information collecting system according to claim 3, wherein the influence degree is calculated as a ratio of a purchase number or a purchase amount obtained when users other than a contributor of an article on particular goods access information on the particular goods based on the article and purchase the particular goods, with respect to a sold number or a sold amount of the particular goods in a predetermined period.

15. A goods information collecting system according to claim 7, wherein the influence degree is calculated as a ratio of a purchase number or a purchase amount obtained when users other than a contributor of an article on particular goods access information on the particular goods based on the article and purchase the particular goods, with respect to a sold number or a sold amount of the particular goods in a predetermined period.

16. A goods information collecting system according to claim 10, wherein the influence degree is calculated as a ratio of a purchase number or a purchase amount obtained when users other than a contributor of an article on particular goods access information on the particular goods based on the article and purchase the particular goods, with respect to a sold number or a sold amount of the particular goods in a predetermined period.

17. A goods information collecting system according to claim 12, wherein the point generating and managing part increases/decreases the point in inverse proportion to a ratio of the number of accesses to information on the goods prior to contribution of an article on the goods, with respect to the desired number of accesses to the goods.

18. A goods information collecting system according to claim 16, wherein the point generating and managing part increases/decreases the point in inverse proportion to a ratio of the number of accesses to information on the goods prior to contribution of an article on the goods, with respect to the desired number of accesses to the goods.

19. A method for collecting information on goods on a network, comprising:
receiving contribution of an article on the goods;
recording and managing the contributed article;
associating the article with information on goods, and generating a link to the information on goods;
displaying the article;
recording and managing an operation history of other users with respect to the displayed article;
calculating an influence degree of the article on sales of the goods based on the operation history; and
generating and managing a point to be an incentive for purchasing goods for each contributor, based on the influence degree,
wherein the point is generated based on the operation history of other users with respect to the contributed article.

20. A computer-readable recording medium storing a program for implementing a method for collecting information on goods on a network, the program comprising:
receiving contribution of an article on the goods;
recording and managing the contributed article;
associating the article with information on goods, and generating a link to the information on goods;
displaying the article;
recording and managing an operation history of other users with respect to the displayed article;
calculating an influence degree of the article on sales of the goods based on the operation history; and
generating and managing a point to be an incentive for purchasing goods for each contributor, based on the influence degree,
wherein the point is generated based on the operation history of other users with respect to the contributed article.
